(19) United States
(12) Patent Application Publication
(10) Pub. No.: US 2021/0078623 A1
(43) Pub. Date: Mar. 18, 2021

(54) Wheeled Pouring Apparatus

(71) Applicant: Benjamin Doman, Bethlehem, GA (US)

(72) Inventor: Benjamin Doman, Bethlehem, GA (US)

(21) Appl. No.: 16/575,131

(22) Filed: Sep. 18, 2019

(51) Int. Cl. B62B 3/08

(52) U.S. Cl. CPC B62B 3/08; B62B 2203/70

(57) ABSTRACT

A wheeled pouring apparatus for moving and pouring concrete and other materials includes a base having a base top side, a base bottom side, a base left side, a base right side, a base front side, and a base back side. A plurality of wheels is coupled to the base bottom side. A pair of supports is coupled to the base top. A bucket is coupled to the pair of supports. The bucket has a bucket left side and a bucket right side each having an axle pivotably coupled between the pair of supports. The bucket pivotably moves between a rest position with an open bucket top side horizontal and an angled pour position. A lip is coupled to the bucket. A lip front side contacts and extends past the base front side with the bucket in the pour position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to construction devices and more particularly pertains to a new construction device for moving and pouring concrete and other materials.

(2) Description of Related Art including information disclosed under 37 CFR 1.97 and 1.98.

The prior art relates to construction devices.

### BRIEF SUMMARY OF THE INVENTION

An embodiment of the disclosure meets the needs presented above by generally comprising a base having a base top side, a base bottom side, a base left side, a base right side, a base front side, and a base back side. A plurality of wheels is coupled to the base bottom side. A pair of supports is coupled to the base top side and extends vertically from proximal the base left side and the base right side. A bucket is coupled to the pair of supports. The bucket has a bucket left side and a bucket right side each having an axle pivotably coupled between the pair of supports, a bucket front side, a bucket back side, a bucket bottom side, and an open bucket top side. The bucket pivotably moves between a rest position with the open bucket top side horizontal and an angled pour position. A lip is coupled to the bucket. The lip has a lip front side, a lip left side, and a lip right side coupled to the bucket front side, the bucket left side, and the bucket right side, respectively. The lip front side contacts and extends past the base front side with the bucket in the pour position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a wheeled pouring apparatus according to an embodiment of the disclosure.

FIG. 2 is an isometric view of an embodiment of the disclosure.

FIG. 3 is a side elevation view of an embodiment of the disclosure.

FIG. 4 is a front elevation view of an embodiment of the disclosure.

### DETAILED DESCRIPTION OF THE INVENTION

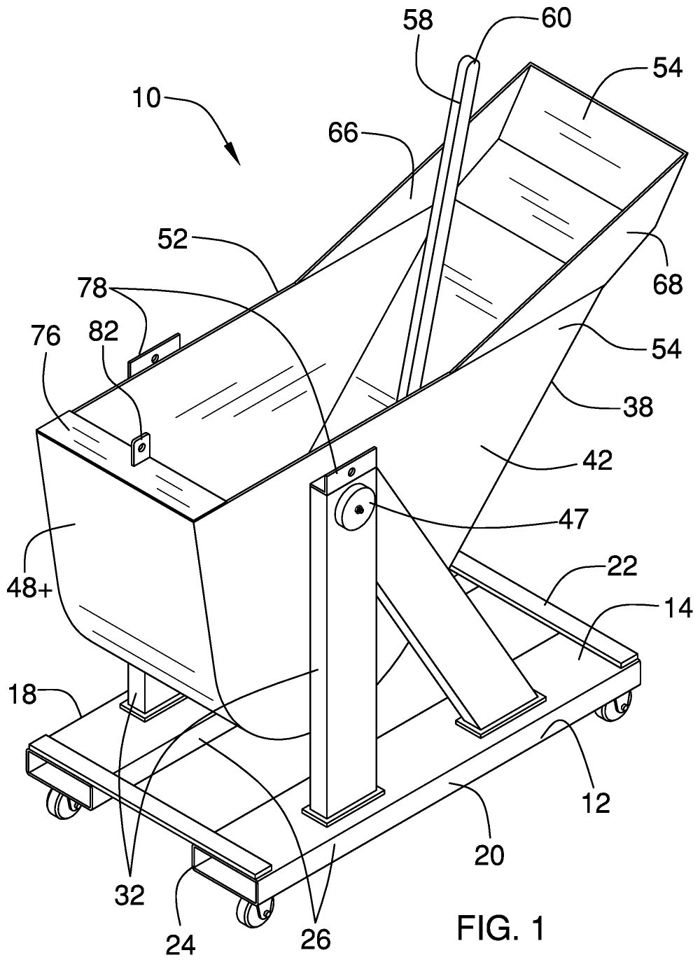

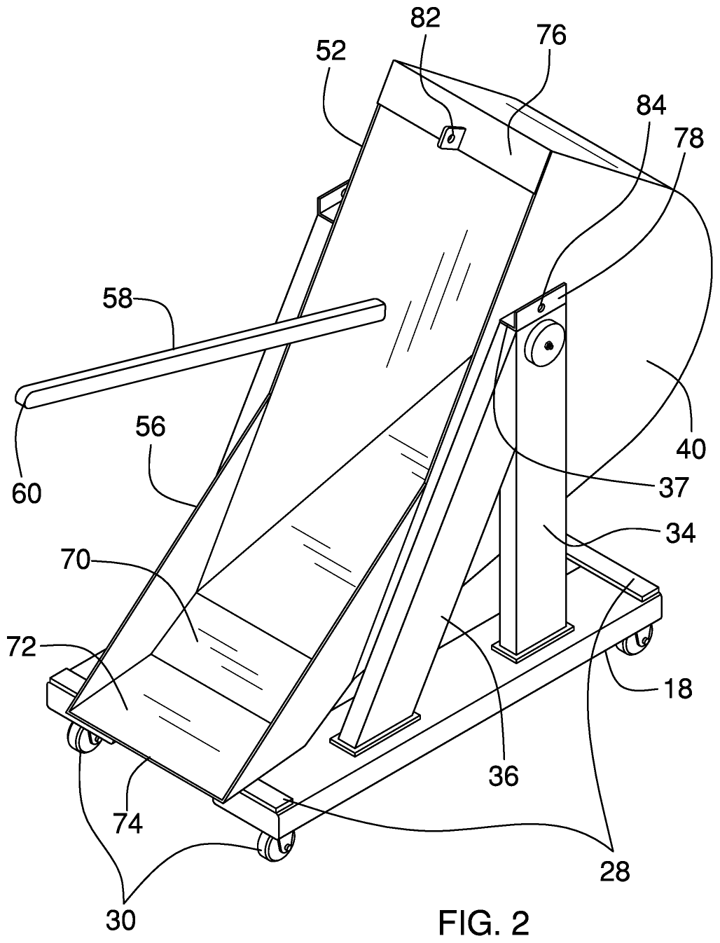

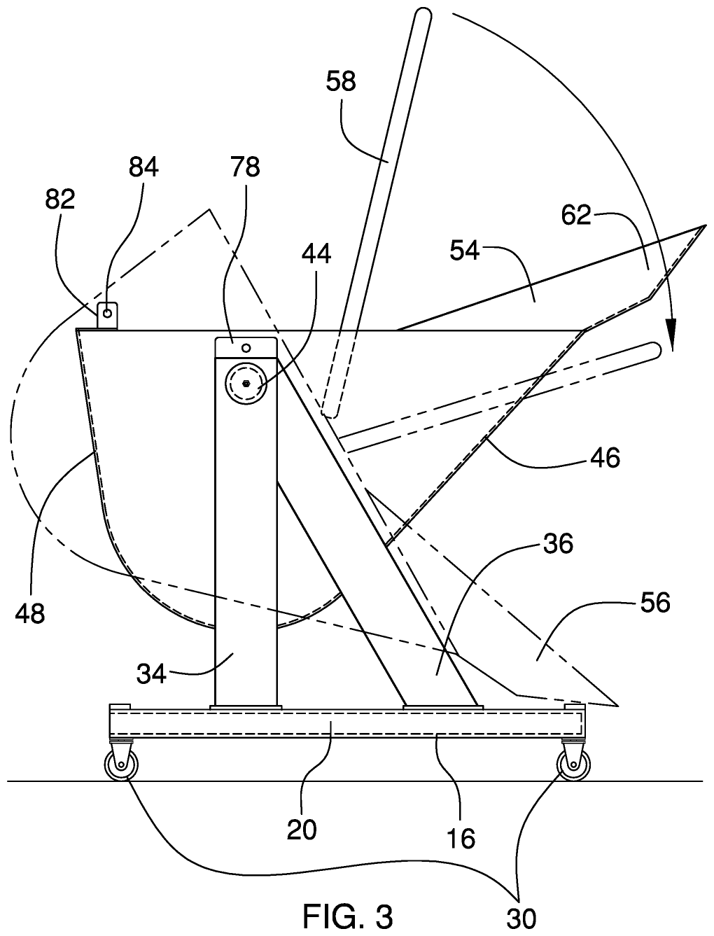

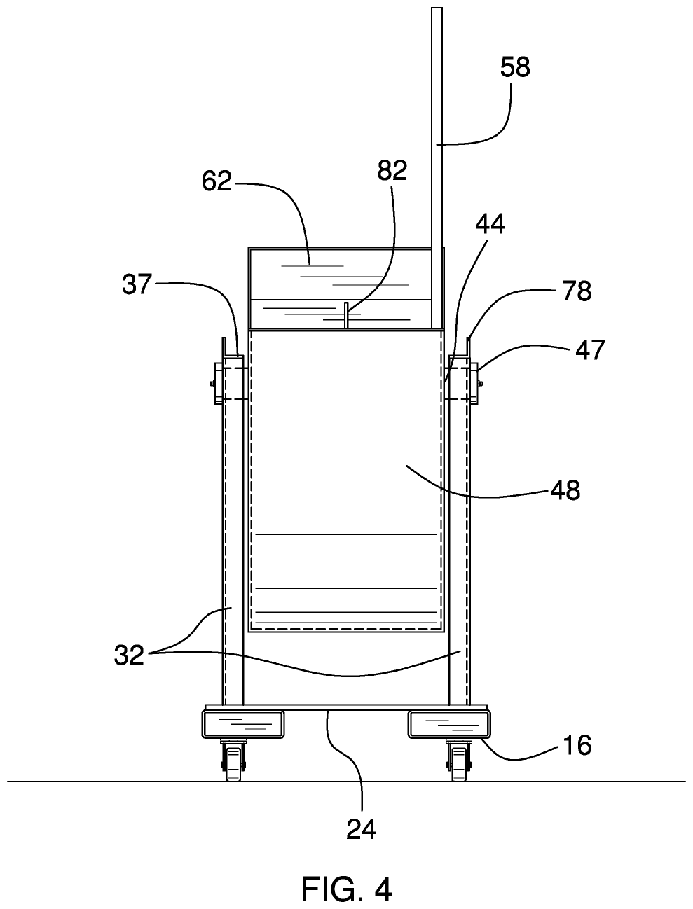

With reference now to the drawings, and in particular to FIGS. 1 through 4 thereof, a new construction device embodying the principles and concepts of an embodiment of the disclosure and generally designated by the reference numeral 10 will be described.

As best illustrated in FIGS. 1 through 4, the wheeled pouring apparatus 10 generally comprises a base 12 having a base top side 14, a base bottom side 16, a base left side 18, a base right side 20, a base front side 22, and a base back side 24. The base 12 comprises a pair of parallel side bars 26 and a pair crossmembers 28. The pair of crossmembers 28 extends perpendicularly across the base top side 14 adjacent the base front side 22 and the base back side 24. A plurality of wheels 30 is coupled to the base bottom side 16. A pair of supports 32 is coupled to the base top side 14 and extends vertically from proximal the base left side 18 and the base right side 20. Each of the supports 32 comprises a vertical post 34 and an angled post 36. The angled post 36 extends from the base top side 14 between the vertical post 34 and the base front side 22 to a top end 37 of the vertical post 34. Each of the supports 32 and each of the side bars 26 may be rectangular tubing.

A bucket 38 is coupled to the pair of supports 32. The bucket 38 has a bucket left side 40 and a bucket right side 42 each having an axle 44 pivotably coupled between the pair of supports 32. The axle 44 may have a circular outer hub 47. The bucket 38 has a bucket front side 46, a bucket back side 48, a bucket bottom side 50, and an open bucket top side 52. The bucket bottom side 50 may be rounded. The bucket front side 46 extends up at an angle closer to horizontal than the bucket back side 48. The bucket 38 pivotably moves between a rest position 54 with the open bucket top side 52 horizontal and an angled pour position 56. A lever 58 is coupled to the bucket 38 and extends above the bucket top side 52. A distal end 60 of the lever 58 may be rounded.

A lip 62 is coupled to the bucket 38. The lip 62 has a lip front side 64, a lip left side 66, and a lip right side 68 coupled to the bucket front side 46, the bucket left side 40, and the bucket right side 42, respectively. The lip front side 64 has a lower portion 70 coupled at an angle to the bucket front side 46 and an upper portion 72 extending at an angle from the lower portion 70. The lower portion 70 lies in a plane parallel to a plane of the bucket front side 46. The upper portion 72 of the lip front side 64 contacts and extends past the base front side 22 with the bucket 38 in the pour position 56. An upper edge 74 of each of the lip left side 66 and the lip right side 68 extends at an angle from the bucket top side 52 to prevent spillage. A cover strap 76 is coupled to each of the bucket back side 48, the bucket left side 40, and the bucket right side 42 and extends across the bucket top side 52. A pair of support attachment ears 78 is coupled to a top end 80 of each of the pair of supports 32. A medial attachment ear 82 is coupled to the cover strap 76. Each of the support attachment ears 78 and the medial attachment ear 82 has an attachment aperture 84 extending therethrough. The support attachment ears 78 and the medial attachment ear 82 allow the apparatus 10 to be attached to a chain and lifted.

In use, the user pours the desired ingredients into the bucket 38. The apparatus 10 is then wheeled to the destination using the plurality of wheels 30. The lever 58 provides leverage to move the bucket 38 from the rest position 54 to the angled pour position 56.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A wheeled pouring apparatus comprising:
a base, the base having a base top side, a base bottom side, a base left side, a base right side, a base front side, and a base back side;
a plurality of wheels coupled to the base, the plurality of wheels being coupled to the base bottom side;
a pair of supports coupled to the base, the pair of supports being coupled to the base top side and extending vertically from proximal the base left side and the base right side;
a bucket coupled to the pair of supports, the bucket having a bucket left side and a bucket right side each having an axle pivotably coupled between the pair of supports, a bucket front side, a bucket back side, a bucket bottom side, and an open bucket top side, the bucket pivotably moving between a rest position with the open bucket top side horizontal and an angled pour position;
a lip coupled to the bucket, the lip having a lip front side, a lip left side, and a lip right side coupled to the bucket front side, the bucket left side, and the bucket right side, respectively, the lip front side contacting and extending past the base front side with the bucket in the pour position; and
a lever coupled to the bucket, the lever having a planar interior side and a parallel planar exterior side, a portion of the exterior side being abutted and affixed to an interior side surface of the bucket, the lever extending above the bucket top side, the lever being in a fixed position relative to the bucket, the lever being angled to extend simultaneously upward away from the bucket and forward towards the bucket front side.

2. (canceled)

3. The wheeled pouring apparatus of claim 1 further comprising the lip front side having a lower portion coupled at an angle to the bucket front side and an upper portion extending at an angle from the lower portion.

4. The wheeled pouring apparatus of claim 3 further comprising the lower portion lying in a plane parallel to a plane of the bucket front side.

5. The wheeled pouring apparatus of claim 1 further comprising each of the supports comprising a vertical post and an angled post, the angled post extending from the base top side between the vertical post and the base front side to a top end of the vertical post.

6. The wheeled pouring apparatus of claim 5 further comprising the base comprising a pair of parallel side bars and a pair crossmembers, the pair of crossmembers extending perpendicularly across the base top side adjacent the base front side and the base back side.

7. The wheeled pouring apparatus of claim 1 further comprising a cover strap coupled to the bucket, the cover strap being coupled to each of the bucket back side, the bucket left side, and the bucket right side and extending across the bucket top side.

8. The wheeled pouring apparatus of claim 7 further comprising a pair of support attachment ears coupled to a top end of each of the pair of supports and a medial attachment ear coupled to the cover strap, each of the support attachment ears and the medial attachment ear having an attachment aperture extending therethrough.

9. A wheeled pouring apparatus comprising:
a base, the base having a base top side, a base bottom side, a base left side, a base right side, a base front side, and a base back side, the base comprising a pair of parallel side bars and a pair crossmembers, the pair of crossmembers extending perpendicularly across the base top side adjacent the base front side and the base back side;
a plurality of wheels coupled to the base, the plurality of wheels being coupled to the base bottom side;
a pair of supports coupled to the base, the pair of supports being coupled to the base top side and extending vertically from proximal the base left side and the base right side, each of the supports comprising a vertical post and an angled post, the angled post extending from the base top side between the vertical post and the base front side to a top end of the vertical post;
a bucket coupled to the pair of supports, the bucket having a bucket left side and a bucket right side each having an axle pivotably coupled between the pair of supports, a bucket front side, a bucket back side, a bucket bottom side, and an open bucket top side, the bucket pivotably moving between a rest position with the open bucket top side horizontal and an angled pour position;
a lever coupled to the bucket, the lever having a planar interior side and a parallel planar exterior side, a portion of the exterior side being abutted and affixed to an interior side surface of the bucket, the lever extending above the bucket top side, the lever being in a fixed position relative to the bucket, the lever being angled to extend simultaneously upward away from the bucket and forward towards the bucket front side;
a lip coupled to the bucket, the lip having a lip front side, a lip left side, and a lip right side coupled to the bucket front side, the bucket left side, and the bucket right side, respectively, the lip front side having a lower portion coupled at an angle to the bucket front side and an upper portion extending at an angle from the lower portion, the lower portion lying in a plane parallel to a plane of the bucket front side, the upper portion of the lip front side contacting and extending past the base front side with the bucket in the pour position;
a cover strap coupled to the bucket, the cover strap being coupled to each of the bucket back side, the bucket left side, and the bucket right side and extending across the bucket top side;
a pair of support attachment ears coupled to a top end of each of the pair of supports; and
a medial attachment ear coupled to the cover strap, each of the support attachment ears and the medial attachment ear having an attachment aperture extending therethrough.
